(19) United States
(12) Patent Application Publication
(10) Pub. No.: US 2004/0083839 A1
(43) Pub. Date: May 6, 2004

(54) Simple bicycle drive shaft transmission

(76) Inventor: Terry Luke Hahn, Edmonton (CA)

Correspondence Address: TERRY HAHN, 474-21 10405 JASPER AV., EDMONTON, AB, T5J 3S2, CA

(21) Appl. No.: 10/286,780

(22) Filed: Nov. 4, 2002

(51) Int. Cl. B62M 11/04

(52) U.S. Cl. 74/344; 280/238

(57) ABSTRACT

This transmission operates by use of a drive shaft, that by being extendible and retractable, can vary in length. Gears on each end of the drive shaft deliver power from one of a number of concentric rings of gear teeth on a pedal drive to a similar arrangement on a wheel drive. The drive shaft by moving between these concentric rings can vary the gear ratios of the power delivered. A cam wheel and spring mounted ball bearings are employed to change the length of the drive shaft and especially, lift the drive shaft off of the pedal drive/wheel drive as it disengages and set it down to engage the next set of concentric gears. An alternative method to the use of a cam wheel that performs the same function is also described. This allows a radial taper to all engaging gears and a deeper seat.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to bicycle transmissions. A means for transferring power from the pedal crankshaft, to the rear wheel, that is adjustable to provide different gear ratios, has been improved upon by this invention.

This invention would be classified under “Machine Element or Mechanism” (74), subsection “Transmissions under Longitudinally slidable in which there is a single slidable bevel gear in mesh with a toothed disk, or one of a plurality of bevel gears for changing the speed” (350) and also, under “Land Vehicles” (280), subsection “Reversing and power ratio change (236).

Prior art dates back as far as 1899 when Greiner (Pat. No. 623,780) described a drive shaft bicycle that employed bevel gears, engaging other bevel gears having a variety of radiuses, on a pedal crankshaft. This design gave a sure transmission of power at different ratios, but required loosening of a bolt and a manual change of the ratio. Since Greiner in 1899, the focus of improving this most efficient of designs has been in improving the manner of shifting between gears. In 1945 Hussey (Pat. No. 2,378,634) described a similar arrangement with the addition of a mechanism to switch between the gear rings without tools. In order for his design to function, the gear teeth had to pass thru each other when gears were changed. This necessitated that the bevel gearing was done away with and replaced by a design where the gear teeth on the shaft are parallel, and on the pedal drive are radial. The resulting misfit causes excessive wear and poor power transmission. In 2000 Pogson (Pat. No. 6,155,127) patented a design that allows the shifting of gears on the fly and the use of bevel gearing. This design lacks a positive method of lifting the bevel gears on and off each other when engaging and disengaging. It relies solely on the front and back angles of the bevel gears to slide over each other. As with Hussey's design, gear teeth that are closer together close to the center, than they are farther to the outside (radial), have to somehow slide over each other. This must make changing gears very difficult. It also limits the force that can be exerted to hold the gear surfaces together, which could allow gear slippage. The casings, which are integral to the design also add weight to the bicycle. The drive shaft is bent in the middle causing unnecessary weight and friction from the change of direction of the rotational force. The spring used to force the pedal multi-ring gear and the drive shaft gear together produces friction and is a source of inertia, as it is in contact with the moving parts. The above are possibly the best of the prior art, which is crowded with magnificent examples of complexity, with attendant added mass, power loss, expense of manufacture, and increased probability of breakdown. Worth mention is the present most commonly used system employing a derailleur system, that uses the flexibility of a chain drive to shift between different sized sprockets at the pedal crankshaft and drive wheel. These devices are imprecise and unreliable. Often, the chain falls off the sprockets entirely. Much of the prior art refers to itself as a chainless bicycle.

### BRIEF SUMMARY OF THE INVENTION

The object of this invention is to provide the most efficient means possible to transfer power, from a pedal crankshaft to a drive wheel, on a bicycle. Especially, the invention must provide the most efficient and effective means possible to vary the gear ratio of that power delivery.

This invention provides a new method of engaging and disengaging the bevel gear at each end of the drive shaft onto and off of the concentric rings of bevel gears at the pedal crankshaft and at the driven wheel hub. The new method employed is to lift the drive shaft gear off of one ring of gears and to set it down onto another ring of gears.

Once the gearing is engaged, the only components of the transmission that move are the pedal gear, the drive shaft and the drive gear. There is no casing integral to the design. A light plastic guard can keep loose clothing safe and clean. The drive shaft is a straight line between the two end gears. The drive shaft is held by spring biased ball bearing assemblies mounted onto the bicycle frame. The gears are forced together at a point of stability, enforced by the springs, and for heavy duty work, can be locked into place. The shifting is precise because of the stability at the point of gear engagement, and easy because the drive shaft is lifted out of engagement, and set back down into engagement. The radial bevel of the gears no longer causes a problem in shifting.

### BRIEF DESCRIPTION OF THE SEVERAL VIEWS OF THE DRAWING

FIG. 1 is a side view of the overall mechanism.

FIG. 2 is a front view.

FIG. 3A is a top view showing a rotary implementation of the invention.

FIG. 3B is a top view showing a linear implementation of the invention.

FIG. 4A is a front view of the ball bearing assembly.

FIG. 4B is a cross-sectional view of the ball bearing assembly, with the addition of a locking mechanism.

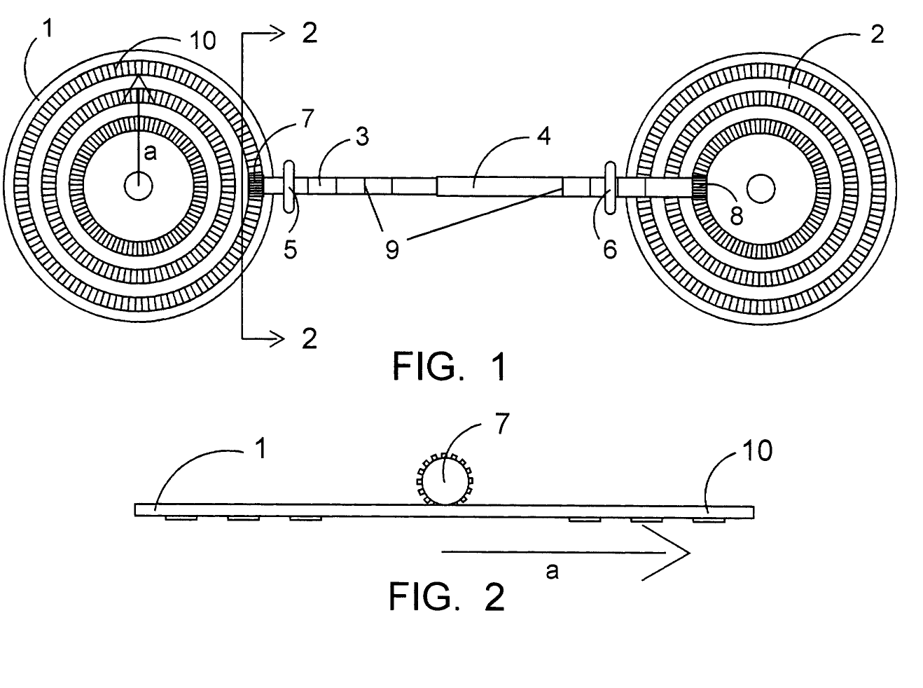

### DETAILED DESCRIPTION OF THE INVENTION

This transmission operates by use of a drive shaft 3&4 that, being extendible and retractable, can vary in length. The drive shaft is constructed of two pieces that are free to slide, one inside the other and at the same time provide rotational rigidity. This is accomplished by using lengthwise teeth, on the outside of the smaller diameter piece and on the inside of the larger diameter piece, that mesh together. Each end of the drive shaft is rigidly attached to a drive shaft bevel gear 7&8. It makes sense to include a spring between the two pieces of the drive shaft, to force them apart, and thus provide the force to change gears in an outward direction.

By engaging the drive shaft at each end 1&2 with one of a number of concentric sets of bevel gear teeth (example 10) having different radius lengths (example a), the transmission can transmit power and change the gear ratios of its delivery by increasing or decreasing the drive shaft length.

The drive shaft is, perhaps adjustably, mounted onto the frame by two ball bearing assemblies 5&6, that allow for lengthwise and rotational motion of the drive shaft. The ball bearing assemblies hold the teeth of the drive shaft, onto the pedal and drive gears by use of a spring 16 that allows movement of the ball bearings 17 perpendicular to the pedal drive 1/wheel drive 2, sufficient to allow the gears to disengage.

For heavy duty applications the drive shaft ball bearings can be locked into place. In such case, the spring 16 is augmented by a metal shaft 18 that is held in place with a spring 20 loaded moveable clip 19. Before shifting the clip is pulled back 21 from the top of, or a notch at the top of, the metal shaft, releasing the metal shaft to move thru the top of the assembly. When the shift is complete, the spring 20 forces the drive shaft back down, and the spring loaded clip re-engages and holds the drive shaft in place. This requires a lighter spring than the original ball bearing assembly design.

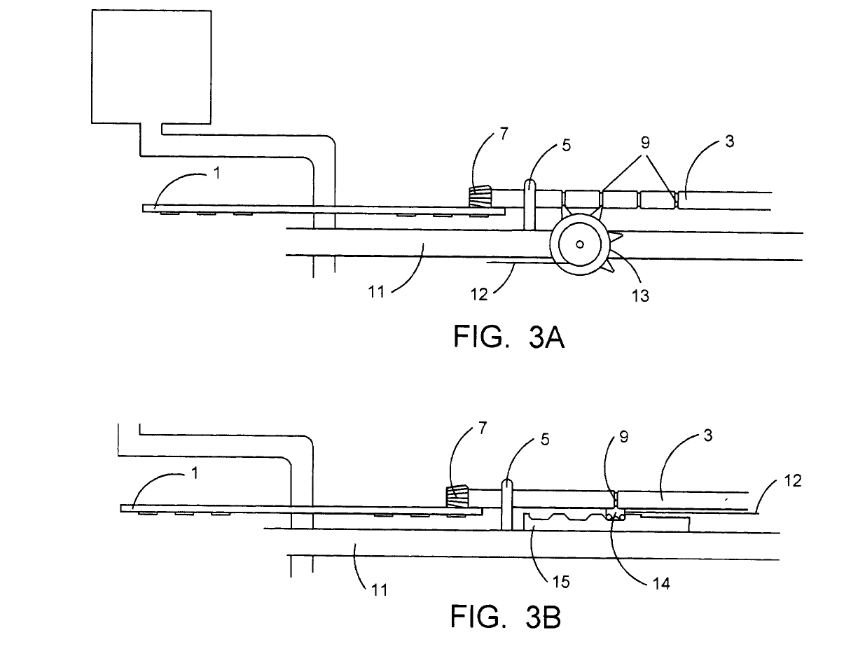

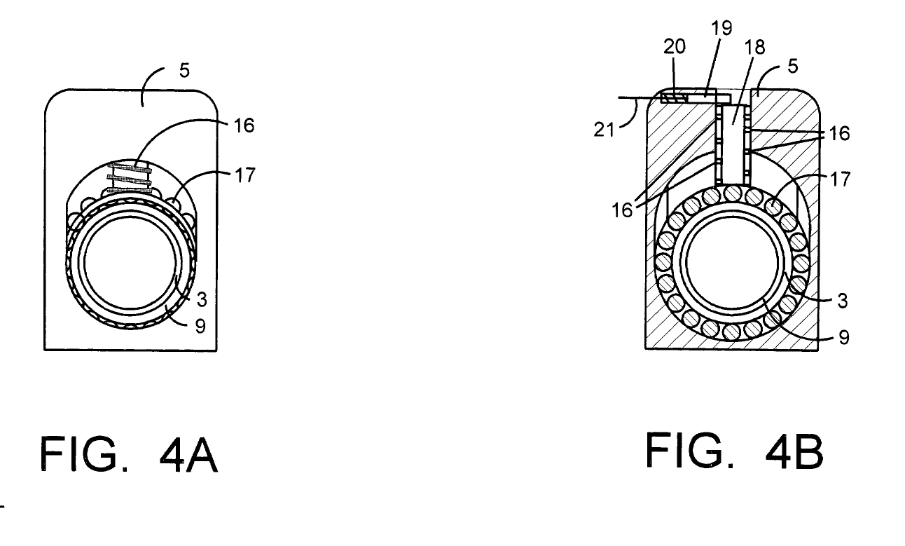

One way to lift the drive shaft bevel gear 7 or 8 off one gear ring and set it down onto another gear ring is a rotational implementation of the gear changing mechanism (FIG. 3A). Gears are changed by rotating a cam wheel 13 that engages notches 9 in the drive shaft. As the cam wheel rotates, a tooth resting in the notch extends or retracts, and lifts the drive shaft 3 or 4. The distance between cams would be the same as the radius difference between two of the concentric ring gears. The cam wheel would be attached to a cable 12 going to the handlebars of the bicycle, and could be spring loaded to move in opposition to the cable, if the two pieces of the drive shaft are not spring loaded. The cam wheel would, perhaps adjustably, mount on the frame 11 of the bicycle.

Another way to change gears by lifting the drive shaft off one gear ring and setting it down onto another gear ring, would be a linear implementation (FIG. 3B). One way to accomplish this is by using a trolley 14 that is pulled forward or back by a control cable 12 going to the handlebars of the bicycle, or by a spring in opposition to a cable going to the handlebars of the bicycle. This trolley is connected to the drive shaft 3 by a notch 9 in the drive shaft into which it protrudes. Any arrangement that allows the drive shaft to rotate unhindered, and allows the trolley to lift, and extend and retract the drive shaft length is useable. The trolley rolls on a track 15 that is adjustably connected to the frame 11. The trolley follows a track that approximates the surface of the pedal gear 1 for changing gears at the pedal, and approximates the surface of the drive gear 2 for changing gears at the drive wheel. When the trolley is pulled over the hills and valleys of the track, it lifts and extends or retracts the drive shaft, and because of the force from the springs of the ball bearing assemblies 5 and 6, it would tend to rest in the valleys, where the drive shaft gear and the ring gears would be in mesh. The trolley can be constructed using roller bearings and/or low friction material. This would be the linear implementation of the gear changing mechanism.

With respect to the above description, it is realized that the optimum dimensional relationships for the parts of the invention, including variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing is considered as illustrative only of the principles of the invention. Since numerous modifications and changes are possible to a skilled artisan, it is undesirable to limit the invention to the exact construction shown.

What I claim as my invention is:

1) A linear gear change mechanism for changing the gear ratios on a drive shaft bicycle. With one end of the drive shaft bevel gears moving between concentric rings of bevel gears of different radii at the pedal crankshaft, the linear gear change mechanism lifts, and extends or retracts, the drive shaft by means of a trolley that is pulled forward or back by a control cable going to the handlebars of the bicycle. This trolley is connected to the drive shaft by a notch in the drive shaft into which it protrudes. Any arrangement that allows the drive shaft to rotate unhindered, and allows the trolley to lift, and extend and retract the drive shaft length is useable. The trolley is connected to a track that is mounted to the frame. The trolley follows a track that approximates the surface of the pedal gear. The same mechanism can be employed at the drive wheel.

2) A rotational gear change mechanism for changing the gear ratios on a drive shaft bicycle. With one end of the drive shaft bevel gears moving between concentric rings of bevel gears of different radii at the pedal crankshaft, the rotational gear change mechanism lifts, and extends or retracts, the drive shaft by means of a cam wheel that is rotated by a control cable going to the handlebars of the bicycle. This cam wheel is connected to the drive shaft by notches in the drive shaft into which it protrudes. Any arrangement that allows the drive shaft to rotate unhindered, and allows the cam wheel to lift, and extend and retract the drive shaft length is useable. The cam wheel is connected to the frame. The distance between the cams would be the same as the radius difference between two of the concentric ring gears. The same mechanism can be employed at the drive wheel.

3) A ball bearing assembly that allows for lengthwise and rotational motion of the drive shaft, and that further allows movement of the ball bearings holding the drive shaft, in opposition to a spring perpendicular to the pedal drive/wheel drive, sufficient to allow the gears to disengage, and used in the operation of the transmission for a bicycle that is described in claim 1 and in claim 2.

4) A ball bearing assembly as described in claim 3, that in addition to the properties described, can lock the drive shaft into place and release it. The spring perpendicular to the pedal drive/wheel drive is augmented by a metal shaft held in place with a spring loaded moveable clip. Before shifting the clip is pulled back from over the metal shaft or from a notch in the metal shaft, releasing the metal shaft to move thru the top of the assembly. When the shift is complete, the spring moves the ball bearings and the drive shaft back down, and the spring loaded clip re-engages and holds the drive shaft in place.
